(19) United States
(12) Patent Application Publication
(10) Pub. No.: US 2024/0062125 A1
(43) Pub. Date: Feb. 22, 2024

(54) METHOD FOR DATA-AND EVENT-DRIVEN TASK COMPLETION IN A COMMUNICATION NETWORK

(71) Applicant: LUXEMBOURG INSTITUTE OF SCIENCE AND TECHNOLOGY (LIST), Esch/Alzette (LU)

(72) Inventor: Djamel Khadraoui, Esch/Alzette (LU)

(21) Appl. No.: 18/259,503

(22) PCT Filed: Dec. 30, 2021
(86) PCT No.: PCT/EP2021/087838

§ 371 Date: Jun. 27, 2023

(30) Foreign Application Priority Data
Dec. 30, 2020 (EP) 20217938.8

(51) Int. Cl. G06Q 10/0631

(52) U.S. Cl. CPC G06Q 10/06311

(57) ABSTRACT

A method for event driven and data driven completion of a task in a communication network, wherein the completion of the task relies on sensitive data of at least one user, wherein a plurality of nodes in said network contribute to the completion of the task by completing a set of sub-tasks thereof. Using the proposed method, fine-grained release of useful sensitive data is accomplished, while the distributed completion of the task is constantly monitored.

### TECHNICAL FIELD

The present invention lies in the field of communication systems. In particular, it relates to communication system in which a plurality of nodes completes a distributed data-driven task.

### BACKGROUND OF THE INVENTION

The coordination of a variety of distributed tasks in a communication network is a largely data driven operation. As an example, clearing a financial transaction is a task in which several actors, i.e., an entity ordering a transaction, a clearing house, a financial institution such as a bank, or a beneficiary entity, or rather computing devices associated with these entities, each perform sub-tasks. Each sub-task relies on data describing the parameters of the transaction: verifying identities, linking identities to accounts, checking balances. Another example lies in the area of logistics. Providers in a logistics chain comprise an originator, parcel delivery services, a postal network and the like. While physical packets are the object of a logistic task, the completion of the physical routing of a packet relies essentially on the completion of another distributed task: the provision of data that drives the packet along the chain. This distributed task is performed by computing devices associated with each of the aforementioned logistics providers, which nowadays tend to be interlinked and provide automated performance of the task. Yet further examples may be found in the organizational planning of complex and dynamic tasks, which are either completely based on digital data processing, or supported by digital data. This may for example be the case in the planning and supervision of construction work sites: different sets of data need to be managed as a function of the completion of sub-sets of the construction work. The data that needs to be managed and controllably released to trusted parties encompasses logistic data such as fleet schedules, construction instructions, safety-related provisions and others.

The data on which such distributed tasks or transactions rely is often privacy sensitive data describing the identity and behaviour of users that have initiated the transaction, or which are the target of the transaction. The data may for example indicate that John S. of T transfers an amount of X Euros to a person living in D, living at a specific address. Coming back to the logistics example, the data may for example indicate that Joan Z. of K has ordered X parcels containing specified goods using a credit card, and that she is or is not at home at specified times during the coming week to accept parcel delivery. In known scenarios, any data that is required by any of the providers that participate in the completion of the distributed task, is available as bulk data to all of the providers. For the user, whose behaviour or identity is described, it becomes increasingly difficult to trace which provider stores and uses the gathered personal information, and to which aims, either with or without the user's explicit consent. The bulk data ends up being available at data warehouses of multiple providers. In complex scenarios, even if the provider to which data is transmitted is deemed to be trustworthy, the transmitted data may not be entirely useful for the completion of the task at hand, as the environment or conditions surrounding the completion of the task may dynamically evolve. Transmitting data to a trustworthy recipient, while the data may in the end not be required or useful at the recipient, exposes the transmitted data to potential security breaches, while it should serve a useful purpose.

Nowadays, data security breaches multiply, wherein dishonest individuals or groups gain unauthorized access to data digitally held by commercial service providers. For the users described by the stolen data, the risk of digital identity theft, unauthorized credit card use, and other illegal use of their data is therefore increased. Although automation of data driven tasks in a setting relying heavily on data communication networks is practical, it also implies risks relating to the security of the data that transits on these networks, and that is potentially stored at nodes in the networks.

### Technical Problem to be Solved

It is an objective to present method and device, which overcome at least some of the disadvantages of the prior art.

### SUMMARY OF THE INVENTION

In accordance with a first aspect of the invention, a method for event driven and data driven completion of a task in a communication network is provided. The completion of the task relies on sensitive data of at least one user. A plurality of nodes in said network contribute to the completion of the task by completing a set of sub-tasks thereof. The completion of each sub-task requires a subset of the sensitive data initially held by an orchestration node, and each node is associated with the completion of a set of sub-tasks. The method comprises the following steps:
a) at the orchestration node, transmitting only the subset of data required to complete a first sub-task to the associated first node, subject to the detection, using detection means, of a state that corresponds to a first predetermined condition that is associated with said first sub-task;
b) upon completion of said first sub-task, generating, at the orchestration node, at least one second predetermined condition and associating it with at least one second sub-task,
c) repeating step a) for at least one of the second sub-tasks.

Preferably, all steps of the method may be repeated until the task is completed.

Preferably, the detection means may comprise at least one node of said communication network. Preferably, the detection means may comprise at least one node which contributed to the completion of at least one of said sub-tasks.

The detection means may further preferably comprise sensing means, comprising any of geographic position sensing means, imaging means, or object detection means. The geographic positioning sensing means may comprise a GNSS receiver or a device configured to estimate a geographic position based on received wireless communication signals.

Said nodes may preferably comprise mobile nodes. The mobile nodes may preferably comprise a tablet computer or a smartphone.

Preferably, the orchestrating node may comprise a memory element in which pieces of data are associated with predetermined sub-tasks. Preferably, the data may be associated to sub-tasks based on user input. The user input may preferably be provided to the orchestrating node using a web-based user interface.

Said at least one second predetermined condition may preferably comprise the condition that at least one predetermined sub-task has been completed.

The at least one second predetermined condition may preferably comprise the condition that the second node is detected at a geographical position that substantially corresponds to a geographical position that is associated with said second sub-task.

The data required to complete a sub-task may preferably comprise digital content comprising instructions, a work schedule, or a vehicle fleet schedule. The digital content may comprise audio and/or video content, preferably adapted in dependence of the level of completion of the first sub-task. The content may be dynamically generated using a machine learning tool.

Preferably, the data required to complete a sub-task may be adapted depending on the detected level of completion of other sub-tasks.

Preferably, the data required to complete a sub-task may comprise at least part of the data identifying constraints related to other sub-tasks, or timing constraints.

Preferably, the detection of completion of a sub-task may comprise detecting a level of completion by comparing the detected state to an expected state, and wherein partial correspondence results in the detection of a partial completion of the sub-task.

The second predetermined conditions for the second sub-task may preferably be generated in dependence of the detected level of completion of the first sub-task.

The step of generating a second predetermined condition for said second sub-task may preferably comprise adapting a previously stored predetermined condition based on the state of completion of said first sub-task. The second predetermined condition may comprise the required presence of a second node in a predetermined location at a predetermined time.

Based on observed levels of completion of previous sub-tasks, predetermined conditions for subsequent sub-tasks may be pre-emptively adapted.

Preferably, a plurality of sub-tasks may be completed in parallel. The same detected state may preferably trigger the completion of at least two second sub-tasks.

At least one node may preferably contribute to the completion of a plurality of sub-tasks.

The predetermined conditions associated with a sub-task may preferably be further transmitted by the orchestrating node to the corresponding node at step a) of the proposed method.

Preferably, each node may delete the data received from the orchestrating node once the associated sub-task has been completed.

The distributed task may preferably be a task in a construction project, such as the completion of a construction work.

Preferably, the network nodes may comprise wireless mobile network node, such as smartphones.

According to a further aspect of the invention, a device for orchestrating the distributed completion of a common task in a communication network is proposed, wherein the completion of said common task relies on sensitive data of a user, wherein a plurality of nodes in said network contribute to the completion of said common task by completing a set of sub-tasks thereof, and wherein the completion of each sub-task requires a subset of the sensitive data initially held in a memory element of the device, the device comprising data processing means and data transmission means, wherein the data processing means are configured for performing the method in accordance with an aspect of the invention.

In accordance with another aspect of the invention, a computer program comprising computer readable code means is proposed, which, when run on a computer, causes the computer to carry out the method in accordance with an aspect of the invention.

In accordance with a final aspect of the invention, a computer program product is proposed, comprising a computer-readable medium on which the computer program according to an aspect of the invention is stored.

The invention provides a method in which an orchestrating node in a communication network, which may for example be a node holding personal privacy sensitive data of a user, selectively transmits portions of said data to other nodes in the communication network, so that these nodes complete a distributed data driven task. Data is only transmitted if the orchestrating ascertains, through the detection of a state of completion, that the data is useful for the completion of the next, or of another, sub-task at any given time. The release of data associated with a sub-task therefore depends on the global level of completion of the task, as detected by detection means, which provide real-world feedback to the orchestration node. The orchestrating node coordinates the distributed performance of the task and maintains control over the data that is transmitted to any of the participating network nodes. In particular, only pieces of information that are necessary for the completion of a sub-task are entrusted to the node associated with the completion of the subtask. This reduces the exposure of privacy sensitive data when a data breach occurs at any of the entrusted nodes. Further, the amount of data that is transmitted is limited to data that is useful at a given moment in time, to a given node in the network, for completing a given sub-task. The approach further reduces the amount of privacy sensitive data that would be available to a third party successfully eavesdropping on a communication channel that connects the orchestrating node to a selected node, as the complete data is rarely transmitted. Further beneficial effects may be achieved depending on the application in which the proposed method is used: for example, if the data that is required to complete a sub-task comprises a driving schedule for a fleet of vehicles in a logistic chain, this schedule may be optimized in light of the completion of previous sub-tasks, resulting in a schedule that may for example reduce carbon emissions, when implemented.

### BRIEF DESCRIPTION OF THE DRAWINGS

Several embodiments of the present invention are illustrated by way of FIGURES, which do not limit the scope of the invention, wherein:

FIG. 1 illustrates a system for operating a method in accordance with a preferred embodiment of the invention.

### DETAILED DESCRIPTION OF THE INVENTION

This section describes aspects of the invention in further detail based on preferred embodiments and on the figures. The FIGURES do not limit the scope of the invention. Details that are described in the context of a particular embodiment are applicable to other embodiments, unless otherwise stated.

Throughout the description, the word “node” is used in the context of a communication system to describe any computing device that is equipped with a wired or wireless networking interface. Examples of a node include but are not limited to a Personal Computer, PC, a laptop computer, a smartphone, a tablet computer, a smart watch, smart Internet of Things, IoT, objects and the like. A node runs an operating system and has access to an information storage system, such as a file system or a structured database. A node may further comprise at least one data processor operatively connected to a memory element, such as a Random-Access Memory, RAM, element, a hard disk drive and/or a Solid-State Drive, SSD, and to a structured data repository, which may for example be implemented by a Structured Query Language, SQL, database residing on the hard disk drive or the SSD. Nodes are interconnected via wired or wireless data communication channels, often using multiple intermediary routing nodes.

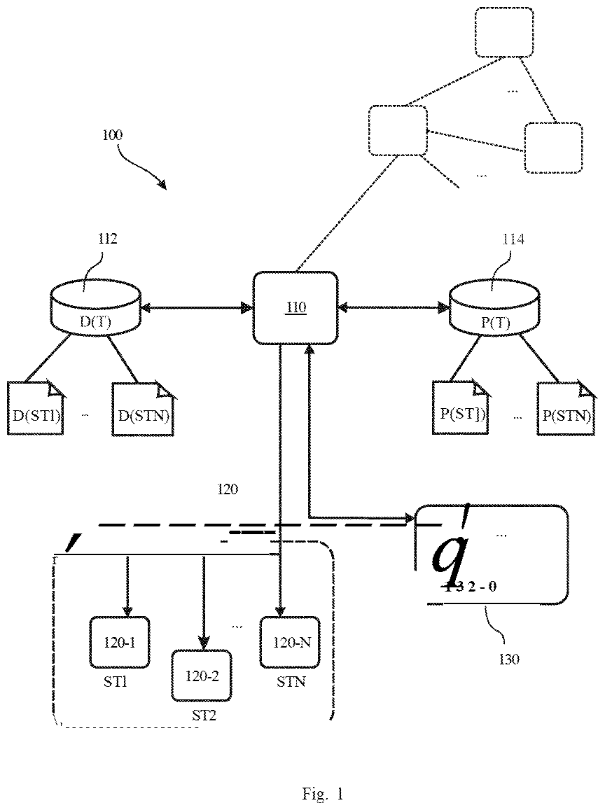

FIG. 1 provides an illustration of a communication network 100 operated to implement a method in accordance with a preferred embodiment of the invention. A data driven task T, the completion of which relies on sensitive data D(T) associated with a user, is to be distributively completed by a set of nodes 120. The nodes may for example comprise smartphones. The task T is broken down into a set of sub-tasks ST1, . . . , STN, and data which is required for the completion of each sub-task. D(ST1), . . . D(STN) is held in a first data store 112 to which an orchestration node 110 has at least read-access.

Preferably, the data D(T) may be privacy sensitive. It may for example comprise details identifying contractors or specific nodes 120-2, 120-2, 120-N in the communication network, to which third parties should not have access. As such, the transmission of this data in the communication network should be limited: it should only be transmitted to a node that actually requires the data at a time, in a place, and under conditions that make the data useful.

Each one of the nodes 120-1, 120-2, 120-N has preferably been pre-selected using selection criteria that may depend on their reliability, availability, trustworthiness or cost. Each one of the nodes is associated with the completion of a set of sub-tasks.

The orchestration node 110 transmits only the subset of data D(ST1) required to complete a first sub-task ST1 to the associated first node 120-1, if a state that corresponds to a first predetermined condition P(ST1), stored in a second data store 114, that is associated with said first sub-task has been detected using detection means 130. A plurality of detection means, possibly distributed among a plurality of corresponding network nodes, may be provided.

The detection means may for example comprise data analysis means capable of detecting data transmission patterns. They may further be capable of detecting and determining the position of a node 120-1 within a predetermined action radius. They may also be capable of picking up radio communication signals in accordance with predetermined communication protocols. Specifically, the detection means may comprise an imaging sensor such as a camera, or audio sensing means. Alternatively or additionally, the detection means may comprise comparison means for comparing a user input, either textual or per audio, video signal, to a predetermined condition.

The first predetermined condition P(ST1), and the detected state, may for example comprise the required presence of node 120-1 at a predetermined position, at which sub-task ST1 is to be completed. Alternatively, or cumulatively, the predetermined condition may comprise the detection of a skilled user at a specified geographical location, through authentication or bio-metric validation, having proven and certified skills for completing sub-task ST1. The predetermined condition may further comprise the detection of objects or tools, through detection of digital tags such as radio-frequency identification, RFID, tags, near field communication, NFC, tags or ultra-wide band, UWB, tags, or through detection based on computer vision.

If the predetermined condition P(ST1) is fully met at a given time, the corresponding data D(ST1) is transmitted to node 120-1. If the condition is partially met, the data may be adapted prior to transmission, or a different node may be selected for completing the task. For example, if an unqualified user is detected based on provided data, such as for example a digital certificate, whereas a qualified user is required, the data D(ST1) may be amended to include more detailed instructions for completing the sub-task ST1.

Completion of the first sub-task is detected by comparing the detected state, using said detection means 132, to an expected result. A captured visual signal may for example be used to detect physical features of objects using a computer vision algorithm, and be compared to a building plan using an artificial intelligence tool. This result may in turn be part of the predetermined condition P(ST2) of a second sub-task ST2. The event of completion may therefore be at least a partial trigger for the release of data D(ST2) required to complete the second sub-task ST2. This event driven mechanism allows to nm multiple sub-tasks in parallel, once the corresponding pre-conditions are detected.

Depending on the level of completion of the first sub-task, the set of second predetermined conditions for at least one further sub-task may preferably be adapted: for example, the time schedule for further tasks may be impacted by the timing of the completion of the first sub-task. If a partial completion of the first sub-task is detected, the second predetermined conditions may further be amended to include the prerequisite completion of a new sub-task, which leads the initially planned first sub-task to a full level of completion, before moving on as initially planned.

The orchestration node 110 itself may be handling a task T in accordance with instructions received from other nodes in the communication networks 100, as shown in dotted lines on FIG. 1. For example, the orchestration node 110 may be orchestrating the completion of task T, which in itself may be a sub-task of a non-illustrated super-task, the completion of which is orchestrated by a non-illustrated super-orchestration node. The proposed structure is therefore a hybrid master-slave structure, in which communication nodes are connected in accordance with a graph structure, which may for example be a hierarchical tree structure.

In accordance with a preferred embodiment, the distributed task T may relate to a construction site, or to multiple construction sites, requiring a plurality of sub-tasks to be completed. Each one of the nodes 120-1, 120-2, etc. . . . may for example comprise a connected device such as a smartphone, and it may be associated with a user of the system, which may for example be an employee, or a person offering services towards the completion of the task.

By way of example, a first sub-task ST1 may comprise the installation of a washing basin at a luxurious yet unsupervised mansion. A predetermined condition P(ST1) may comprise the availability of a person at a given date, equipped with a predetermined set of tools and having a predetermined skill set. If this condition is not satisfied, no location of the mansion should be provided to the user. In order to associate a node 120-1, 120-2, . . . with the subtask, the orchestrating node may for example transmit a query to the nodes. Users providing their replies to this query provide input into the system 100. A detection node 130 checks the user input and determines whether one of the users associated with any of the queried node satisfied the set of predetermined conditions P(ST1). If that is the case, the corresponding node, for example node 120-1 is associated with the sub-task ST1. On the scheduled day, a coarse or rough position information is transmitted to the node 120-1, so that the corresponding user is enabled to make their way to the yet undisclosed location of the mansion. While moving, the node 120-1 may transmit GPS position data to the orchestrating node or to the detecting node, which checks whether the selected node is on track and on time. If that is not the case, another node 120-2 may be selected to do the task. If all conditions are satisfied, the finally elected node is provided with the exact location once it moves closer to destination, preserving the privacy of the mansion's holder unless absolutely necessary for the completion of the task at hand. Upon arrival, which marks an event, the presence of the required tools is checked via RFID tags attached thereto or via video communication with the orchestrating node. If all second preconditions are satisfied, the next sub-task is ready to be executed. Instructions for completing the sub-task (i.e. data associated with the sub-task) at hand are transmitted from the orchestrating node to the selected node 120-1. These may for example comprise video streamed instructions. Depending on the level of skill of the user whose node 120-1 was selected, the instructions may be more or less detailed: only those data that will be useful to the user at hand will therefore be transmitted, which reduces unnecessary data transmissions, thereby reducing the overall load on the data communication network.

A further detecting node 130 on site, or via input of the node 120-1 (for example by photography or video stream), compares the installation of the washing basin with a predetermined construction plan and validates the completion of the sub-task only if the installation complies with the plan. This event then triggers the planning of the next sub-task in the construction project, which may require different skills, different data at a different time.

If the installation does not comply with the plan, a new sub-task may be generated and scheduled for completion. The new sub-task may for example require the collaboration of a network node associated with a more skilled worker.

In accordance with another preferred embodiment, multiple nodes detected as having complementary skills, tools and/or availabilities may be associated with the same sub-task.

It should be noted that features described for a specific embodiment described herein may be combined with the features of other embodiments unless the contrary is explicitly mentioned. Based on the description and on the FIGURE that has been provided, a person with ordinary skills in the art will be enabled to develop a computer program for implementing the described methods without undue burden and without requiring any additional inventiveness.

It should be understood that the detailed description of specific preferred embodiments is given by way of illustration only, since various changes and modifications within the scope of the invention will be apparent to the person skilled in the art. The scope of protection is defined by the following set of claims.

1. A computer-implemented method for event driven and data driven completion of a task in a communication network, wherein the completion of the task relies on sensitive data of at least one user, wherein a plurality of nodes includes a first node and a second node, wherein the plurality of nodes in said network contribute to the completion of the task by completing a set of sub-tasks thereof, wherein the completion of each sub-task requires a subset of the sensitive data initially held by an orchestration node, and wherein each of the nodes is associated with the completion of a set of sub-tasks, the method comprising the following steps:
a) at the orchestration node, transmitting only the subset of data required to complete a first sub-task to the associated first node, subject to a detection, using detection means, of a state that corresponds to a first predetermined condition that is associated with said first sub-task;
b) upon completion of said first sub-task, generating, at the orchestration node, at least one second predetermined condition and associating it with at least one second sub-task;
c) repeating step a) for at least one of the second sub-tasks.

2. The computer-implemented method in accordance with claim 1, wherein the detection means comprise at least one of the nodes of said communication network.

3. The computer-implemented method in accordance with claim 1, wherein the detection means comprise sensing means, comprising any of geographic position sensing means, imaging means, or object detection means.

4. The computer-implemented method in accordance with claim 1, wherein said at least one second predetermined condition comprises the condition that at least one predetermined sub-task has been completed.

5. The computer-implemented method in accordance with claim 1, wherein said at least one second predetermined condition comprises the condition that the second node is detected at a geographical position that substantially corresponds to a geographical position that is associated with said second sub-task.

6. The computer-implemented method in accordance with claim 1, wherein said data required to complete a sub-task comprises digital content comprising instructions, a work schedule, or a vehicle fleet schedule.

7. The computer-implemented method in accordance with claim 1, wherein the detection of completion of a sub-task comprises detecting a level of completion by comparing the detected state to an expected state, and wherein partial correspondence results in the detection of a partial completion of the sub-task.

8. The computer-implemented method in accordance with claim 7, wherein the second predetermined conditions for the second sub-task are generated in dependence of the detected level of completion of the first sub-task.

9. The computer-implemented method in accordance with claim 1, wherein the step of generating a second predetermined condition for said second sub-task comprises adapting a previously stored predetermined condition based on the state of completion of said first sub-task.

10. The computer-implemented method in accordance with claim 1, wherein at least one of the nodes contributes to the completion of a plurality of sub-tasks.

11. The computer-implemented method in accordance with claim 1, wherein the predetermined conditions associated with a sub-task are further transmitted to the corresponding node by the orchestrating node to the corresponding node at step a).

12. The computer-implemented method according to claim 1, wherein said distributed task is a task in a construction project.

13. The computer-implemented method according to claim 1, wherein said network nodes comprise wireless mobile network node, such as smartphones.

14. A device for orchestrating a distributed completion of a common task in a communication network comprising at least one memory element and a processor, wherein the completion of said common task relies on sensitive data of a user, wherein a plurality of nodes in said network contribute to the completion of said common task by completing a set of sub-tasks thereof, and wherein the completion of each sub-task requires a subset of the sensitive data initially held in the memory element of the device, wherein the processor is configured for:
a) transmitting only the subset of data required to complete a first sub-task to the associated first node, subject to a detection, using detection means, of a state that corresponds to a first predetermined condition that is associated with said first sub-task;
b) upon completion of said first sub-task, generating, at the orchestration node, at least one second predetermined condition and associating it with at least one second sub-task;
c) repeating step a) for at least one of the second sub-tasks.

15. A non-transitory computer readable storage medium storing instructions that when executed by a computer, which includes a processor perform a method for event driven and data driven completion of a task in a communication network, wherein the completion of the task relies on sensitive data of at least one user, wherein a plurality of nodes includes a first node and a second node, wherein the plurality of nodes in said network contribute to the completion of the task by completing a set of sub-tasks thereof, wherein the completion of each sub-task requires a subset of the sensitive data initially held by an orchestration node, and wherein each of the nodes is associated with the completion of a set of sub-tasks, the method comprising:
a) at the orchestration node, transmitting only the subset of data required to complete a first sub-task to the associated first node, subject to a detection, using detection means, of a state that corresponds to a first predetermined condition that is associated with said first sub-task;
b) upon completion of said first sub-task, generating, at the orchestration node, at least one second predetermined condition and associating it with at least one second sub-task;
c) repeating step a) for at least one of the second sub-tasks.

16. (canceled)

17. The method according to claim 1, wherein said network nodes comprise smartphones.
